(19) United States
(12) Patent Application Publication
(10) Pub. No.: US 2015/0285194 A1
(43) Pub. Date: Oct. 8, 2015

(54) Energy-Saving and Emission-Reducing Apparatus for Disturbing and Boosting Mixture Gas of Fuel Oil Engine

(71) Applicant: Wenxin Xu, Chongqing (CN)

(72) Inventor: Wenxin Xu, Chongqing (CN)

(21) Appl. No.: 14/417,533

(22) PCT Filed: Aug. 12, 2013
(86) PCT No.: PCT/CN2013/000951

§ 371 Date: Jan. 26, 2015

(30) Foreign Application Priority Data
Sep. 3, 2012 (CN) 201210319624.0
Sep. 3, 2012 (CN) 201220442815.1

(51) Int. Cl. F02M 29/08; B01F 3/04; B01F 15/02; F02M 29/02

(52) U.S. Cl. CPC F02M 29/08; F02M 29/02; B01F 3/04021; B01F 15/0254; B01F 2215/0086

(57) ABSTRACT

Disclosed is an improved energy-saving and emission-reducing apparatus for disturbing and boosting a mixture gas of a fuel oil engine. A spring-shaped device and a propeller-shaped device for further increasing the degree of mixing and atomizing of the mixture gas are provided in an engine carburetor foam tube (2), a choke tube (7) and the whole mixture gas channel. The device can be used to increase the degree of mixing and atomizing of the mixture gas and realize more timely and complete combustion of the fuel, thus achieving the purpose of saving energy and reducing emissions.

### CROSS REFERENCE OF RELATED APPLICATION

This is a national phase national application of an international patent application number PCT/CN2013/000951 with a filing date of Aug. 12, 2013, which claimed priority of foreign application number 201210319624.0 with a filing date of Sep. 3, 2012 and 201220442815.1 with a filing date of Sep. 3, 2012 in China. The contents of these specifications, including any intervening amendments thereto, are incorporated herein by reference.

### BACKGROUND OF THE PRESENT INVENTION

1. Field of Invention

The present invention relates to a fuel oil engine, and in particular to carburetor and tube for premixed gas passage of an engine.

2. Description of Related Arts

The task of atomization and mixing of fuel and air in a conventional fuel oil engine is mainly completed inside the bubble tube of the carburetor, the hose of the engine and the entire premixed gas passage.

Under the vacuum suction from air suction force of piston action, the fuel inside the cylinder of an engine which is equipped with a carburetor is first entered from the main jet of the carburetor into the bubble tube, and under the vacuum suction of the flowing fuel, the fuel is first mixed with the air which is entered into the bubble tube from the micro vent. Then, the fuel undergoes secondary mixing and atomization with the air which is entered into the tube body. Finally, the fuel enters into the cylinder of the combustion engine and is ignited by the spark plug to produce the combustion gas at high temperature and high pressure to drive the piston and other mechanical parts to work.

The atomization and mixing of fuel and air in an Electronic Fuel Injection (EFI) engine is mainly completed inside the hose of the engine and the entire premixed gas passage.

Conventional bubble tube of carburetor and hoses technology have the drawback of insufficient and uneven mixing of fuel and air, therefore the fuel particles cannot be sufficiently atomized, causing the problems of incomplete and untimely combustion, insufficiently energy release, waste of fuel and high level of pollution emission.

### SUMMARY OF THE PRESENT INVENTION

An object of the present invention is to solve the problems of insufficient and uneven mixing of fuel and air by providing a spring-like or a propeller-like spoiler device for gas mixture.

In order to solve the above problem, the present invention provides a spring-like spoiler device inside the bubble tube of carburetor such that the gas entering into the bubble tube from the micro gas passage can have more sufficient mixing with the fuel, and then through the spoiler effect of the spring-like spoiler device or non-main power propeller device in the channel of hose passage, the level of mixing and atomization is further increased.

The non-main power propeller device is installed inside the channel of hose passage of the engine. The propeller device is driven to rotational movement by the high speed airflow generated by the engine, thereby the mixing and atomization of fuel particles and air is more sufficient and uniform.

The advantageous effect of the present invention is: through the spring-like spoiler device in the bubble tube of carburetor and the spoiler effect of the spring-like device or the non-main power propeller device inside the channel of hose passage, the mixing and atomization of fuel and air is more sufficient and uniform. Then, the fuel is transmitted to the cylinder for ignition and work, and the result is that the combustion is more sufficient and timely, the power output is greater, the fuel consumption is reduced, and the pollution emission is reduced while the cost is low.

In a test with a dynamometer for a 150cc engine of motorcycle, the average torque increase is 0.344N.m. at 3000-6000r, which is 4%, and is 0.8N.m. at 3000r, which is 11%.

### BRIEF DESCRIPTION OF THE DRAWINGS

FIG. 1 is a structural illustration of a spring-like spoiler device according to the preferred embodiment of the present invention.

1. Carburetor; 2. Bubble tube; 3 position base of spring-like spoiler device in the channel of engine hose passage; 4. Spring-like spoiler device in a bubble tube; 5. Spring-like spoiler device in the channel of hose passage; 6. Gas mixture (of fuel and air); 7. Channel and engine hose passage; 8. Micro vent; 9. Position base of spring-like spoiler device in the bubble tube; 10. Main jet; 11. Fuel; 12. Air

FIG. 2 is a structural illustration of a propeller-like spoiler device according to the preferred embodiment of the present invention.

1. Front view of a propeller-like spoiler device; 2. Side view of a propeller-like spoiler device; 3. Channel of engine hose passage; 4. Position base of a propeller-like spoiler device; 5. Connector ring; 6. Cylinder

### DETAILED DESCRIPTION OF THE PREFERRED EMBODIMENT

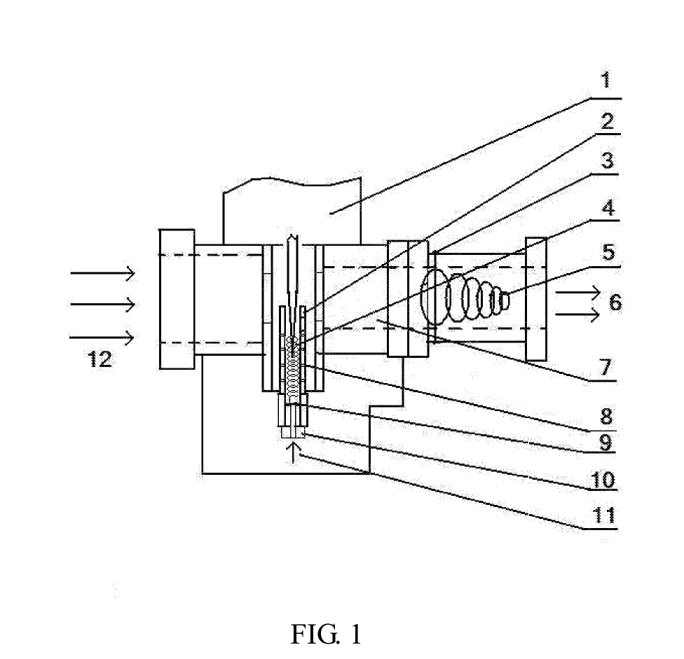

As shown in FIG. 1 of the drawings, a ring-shaped position base is provided on the spring-like spoiler device in a bubble tube, therefore the ring-shaped position base is installed onto the bubble tube through screwing through the main vent. This arrangement can facilitate removal, cleaning and replacement of the spoiler device.

As shown in FIG. 1 of the drawings, a +-shaped position base is provided for the spring-like spoiler device in a channel of engine hose, and is installed inside the channel of hose passage engine hose and the connecting tube of a cylinder.

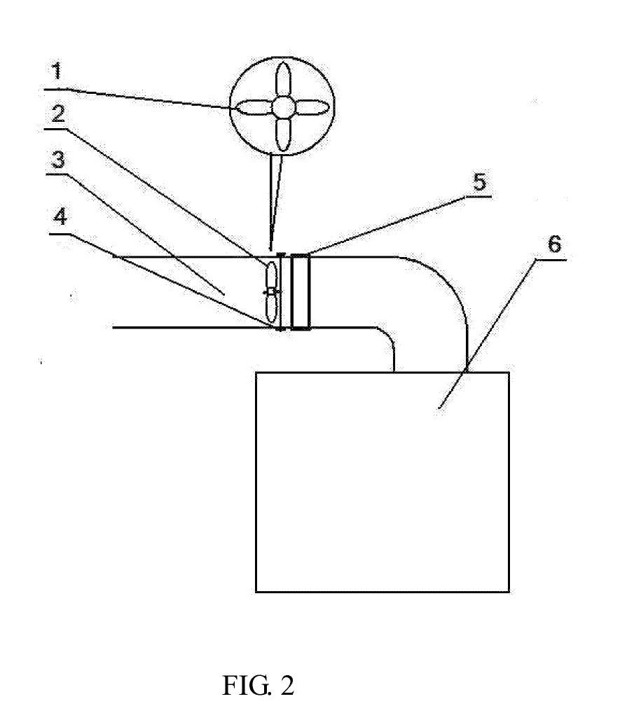

As shown in FIG. 2 of the drawings, a +-shaped position base which is similar to the one described in FIG. 1 is provided for the propeller-like spoiler device.

Description: the present invention can be applied to all types of fuel engine.

It will be readily be understood by one having ordinary skill in the relevant art that many embodiments, such as adaptations, variations, modifications and equivalent arrangements will be implicitly disclosed by the embodiments described herein and fall within the scope of the present invention. Accordingly, the present invention encompasses all technologies related to adding a fuel air mixing device to the bubble tube of the carburetor and/or to the channel of the hose passage.

What is claimed is:

1. An improved power, energy-saving, emission-reducing, airflow breaking up enhancing device for mixing fuel and air in a fuel engine, characterized in that, said device comprises a spoiler effect enhancing device installed in a bubble tube of a carburetor, in a channel of engine hose, and in the entire mixed gas passage, and improves the degree of mixing and atomization of the fuel-air mixed gas.

2. The improved power, energy-saving, emission-reducing, airflow breaking up enhancing device for mixing fuel and air in a fuel engine according to claim 1, characterized in that, said spoiler effect enhancing device for mixing the fuel and the air in the fuel engine is a spring-shaped device or other device having a different shape from said spring-shaped and is deriving from said spring-shaped device which is installed in the bubble tube of the carburetor.

3. The improved power, energy-saving, emission-reducing, airflow breaking up enhancing device for mixing fuel and air in a fuel engine according to claim 1, characterized in that, said spoiler effect enhancing device for mixing the fuel and the air in the fuel engine is a spring-shaped device or other device having a different shape from said spring-shaped and deriving from said spring-shaped device which is installed in the channel of hose passage and in the entire premixed gas passage.

4. The improved power, energy-saving, emission-reducing, airflow breaking up enhancing device for mixing fuel and air in a fuel engine according to claim 1, characterized in that, said spoiler effect enhancing device for mixing the fuel and the air in the fuel engine is a propeller-shaped device or other device having a different shape from said propeller-shaped and deriving from said propeller-shaped device which is installed in the channel of hose passage and in the entire premixed gas passage.
